(19) United States
(12) Patent Application Publication
(10) Pub. No.: US 2013/0182284 A1
(43) Pub. Date: Jul. 18, 2013

(54) INFORMATION PROCESSING APPARATUS, MOBILE TERMINAL, PRINTING SYSTEM, AND PRINT CONTROL METHOD

(71) Applicant: Canon Kabushiki Kaisha, Tokyo (JP)

(72) Inventor: Hiroshi Oya, Kawasaki-shi (JP)

(73) Assignee: Canon Kabushiki Kaisha, Tokyo (JP)

(21) Appl. No.: 13/692,634

(22) Filed: Dec. 3, 2012

(30) Foreign Application Priority Data
Jan. 17, 2012 (JP) 2012-007382

(51) Int. Cl. H04W 4/14; G06F 3/12

(52) U.S. Cl. CPC H04W 4/14; G06F 3/12
USPC 358/1.15; 455/466

(57) ABSTRACT

An information processing apparatus determines whether e-mail acquired includes request information requesting a printer list. When the information processing apparatus determines that the e-mail includes the request information, it acquires a list of controllable printers. The information processing apparatus transmits, as a response to the request, e-mail including the printer list. A mobile terminal transmits e-mail including the request information, and receives e-mail including a printer list. The mobile terminal displays the printer list on the display. The mobile terminal accepts selection of a printer on the printer list to transmit e-mail to which the file to be printed by the selected printer is attached.

### BACKGROUND OF THE INVENTION

1. Field of the Invention

The present invention relates to an information processing apparatus which controls a printer, a mobile terminal which requests printing, a printing system including them, and a print control method.

2. Description of the Related Art

There has conventionally been known a printing system in which the e-mail application of a mobile terminal attaches a file the user wants to print to e-mail and transmits the e-mail to a printer to print (Japanese Patent Laid-Open No. 2004-220606). In the printing system, an e-mail address is assigned in advance to a printer. E-mail is transmitted to the e-mail address, and a file attached to the e-mail is printed. To implement such a printing system, the printer requests an e-mail address of a server, and acquires and holds the unique e-mail address in initial setting of the printer. A file the user wants to print is transmitted as a file attached to e-mail from the mobile terminal of the user to the e-mail address.

There is also known a system in which a dedicated adapter is installed between a server and a printer to implement printing of a file attached to e-mail from a mobile terminal (Japanese Patent Laid-Open No. 2001-312392).

In this printing system, to select a printer the user wants from a plurality of printers on a network, he needs to know in advance a mail address assigned to the printer. Especially in an environment where many printers are used, it is very cumbersome for the user to memorize the mail addresses of all printers.

To solve this, for example, a mail address uses a printer name so that the user can easily memorize the mail address of a printer of his choice. In this case, however, the user needs to know the name of a printer by which he wants to print. Even if the user knows the printer name, the printer name may be changed to another one in printing because the printer name is freely changeable. In this case, it is difficult for the user to correctly designate a printer of his choice.

### SUMMARY OF THE INVENTION

An aspect of the present invention is to eliminate the above-mentioned problems with the conventional technology. The present invention provides an information processing apparatus, mobile terminal, printing system, and print control method which allow the user to easily designate a printer of his choice in a printing method using e-mail.

The present invention in its first aspect provides an information processing apparatus comprising: an e-mail acquisition unit configured to acquire e-mail; a determination unit configured to determine whether the e-mail acquired by the e-mail acquisition unit includes request information requesting a printer list; a list acquisition unit configured to acquire a list of printers controllable by the information processing apparatus in a case where the determination unit determines that the e-mail includes the request information; and a transmission unit configured to transmit, as a response to the request, e-mail including the printer list acquired by the list acquisition unit.

The present invention in its second aspect provides a mobile terminal comprising: a first e-mail transmission unit configured to transmit e-mail including request information requesting a printer list; an e-mail reception unit configured to receive e-mail including the printer list; a display control unit configured to display, on a display unit of the mobile terminal, the printer list included in the e-mail received by the e-mail reception unit; an acceptance unit configured to accept selection of a printer on the printer list displayed on the display unit; and a second e-mail transmission unit configured to transmit e-mail to which the file to be printed by the selected printer is attached.

The present invention in its third aspect provides a printing system in which a mobile terminal requests an information processing apparatus to print a file, the information processing apparatus comprising: an e-mail acquisition unit configured to acquire e-mail; a determination unit configured to determine whether the e-mail acquired by the e-mail acquisition unit includes request information requesting a printer list; a list acquisition unit configured to acquire a list of printers controllable by the information processing apparatus in a case where the determination unit determines that the e-mail includes the request information; and a first transmission unit configured to transmit, as a response to the request, e-mail including the printer list acquired by the list acquisition unit, and the mobile terminal comprising: a second transmission unit configured to transmit e-mail including request information; a reception unit configured to receive e-mail including the printer list; a display control unit configured to display, on a display unit of the mobile terminal, the printer list included in the e-mail received by the reception unit; an acceptance unit configured to accept selection of a printer on the printer list displayed on the display unit; and a third transmission unit configured to transmit e-mail to which the file to be printed by the selected printer is attached.

The present invention in its fourth aspect provides a print control method to be executed in a printing system in which a mobile terminal requests an information processing apparatus to print a file, comprising: in the information processing apparatus, an e-mail acquisition step of acquiring e-mail; a determination step of determining whether the e-mail acquired in the e-mail acquisition step includes request information requesting a printer list; a list acquisition step of acquiring a list of printers controllable by the information processing apparatus in a case where the e-mail is determined in the determination step to include the request information; and a first transmission step of transmitting, as a response to the request, e-mail including the printer list acquired in the list acquisition step, and in the mobile terminal, a second transmission step of transmitting e-mail including the request information; a reception step of receiving e-mail including the printer list; a display control step of displaying, on a display unit of the mobile terminal, the printer list included in the e-mail received in the reception step; an acceptance step of accepting selection of a printer on the printer list displayed on the display unit; and a third transmission step of transmitting e-mail to which the file to be printed by the selected printer is attached.

According to the present invention, the user can easily designate a printer of his choice.

Further features of the present invention will become apparent from the following description of exemplary embodiments with reference to the attached drawings.

### BRIEF DESCRIPTION OF THE DRAWINGS

FIG. 1 is a view showing the overall configuration of a printing system;

FIG. 2 is a block diagram showing the internal arrangement of an access point;

FIG. 3 is a block diagram showing the internal arrangement of a mail server and print server;

FIG. 4 is a block diagram showing the internal arrangement of a printer;

FIG. 5 is a block diagram for explaining an e-mail transmission/reception operation;

FIG. 6 is a flowchart showing a sequence until the printer prints a file the user wants to print;

FIG. 7 is a flowchart showing the detailed procedures of processes in steps S631 to S635 of FIG. 6;

FIG. 8 is a table showing the correspondence between a file extension and an application;

FIG. 9 is a table showing the correspondence between a printer driver and a printer name;

FIG. 10 is a flowchart showing processing procedures until a printer list is transmitted;

FIG. 11 is a view exemplifying an e-mail transmission screen;

FIG. 12 is a view exemplifying a transmission screen when acquiring a printer list;

FIG. 13 is a view exemplifying an e-mail reception screen;

FIG. 14 is a view exemplifying an e-mail transmission screen when a printer is selected; and

FIG. 15 is a block diagram for explaining another e-mail transmission/reception operation.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

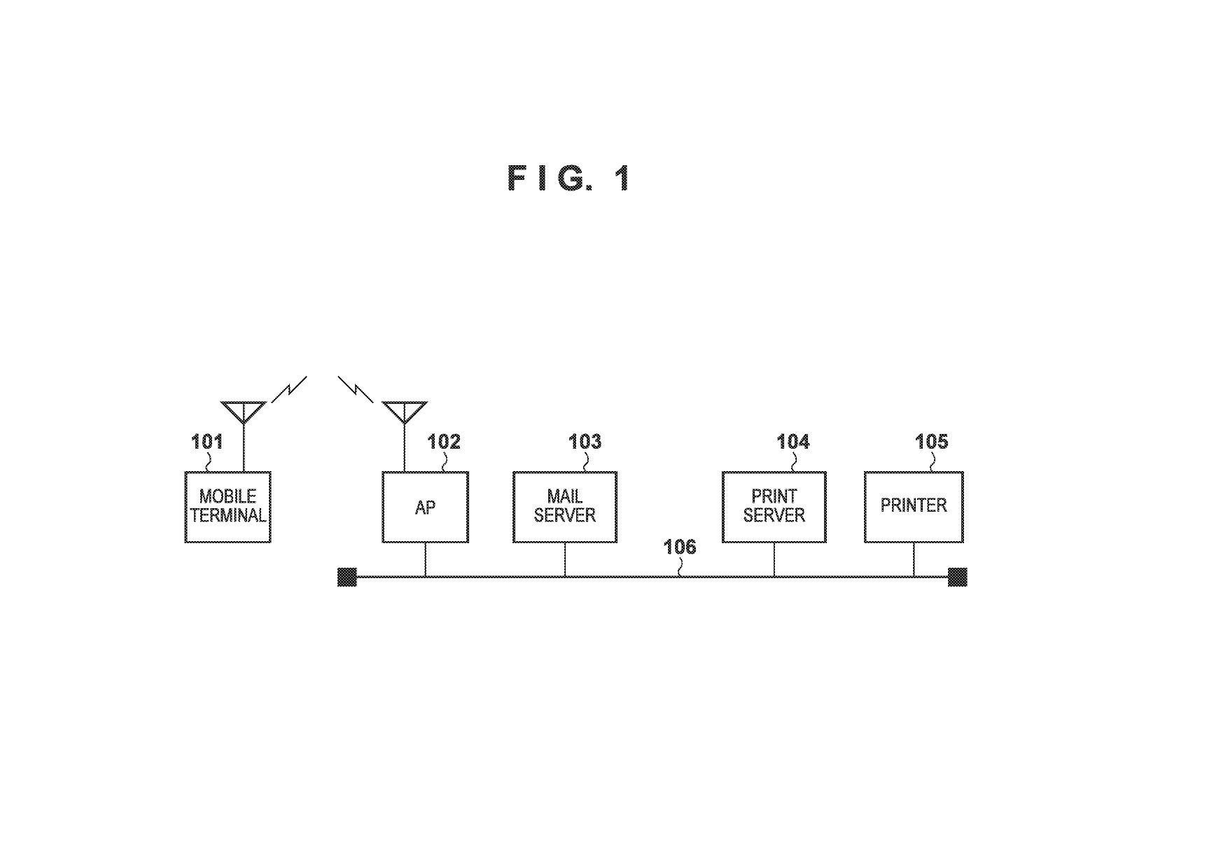

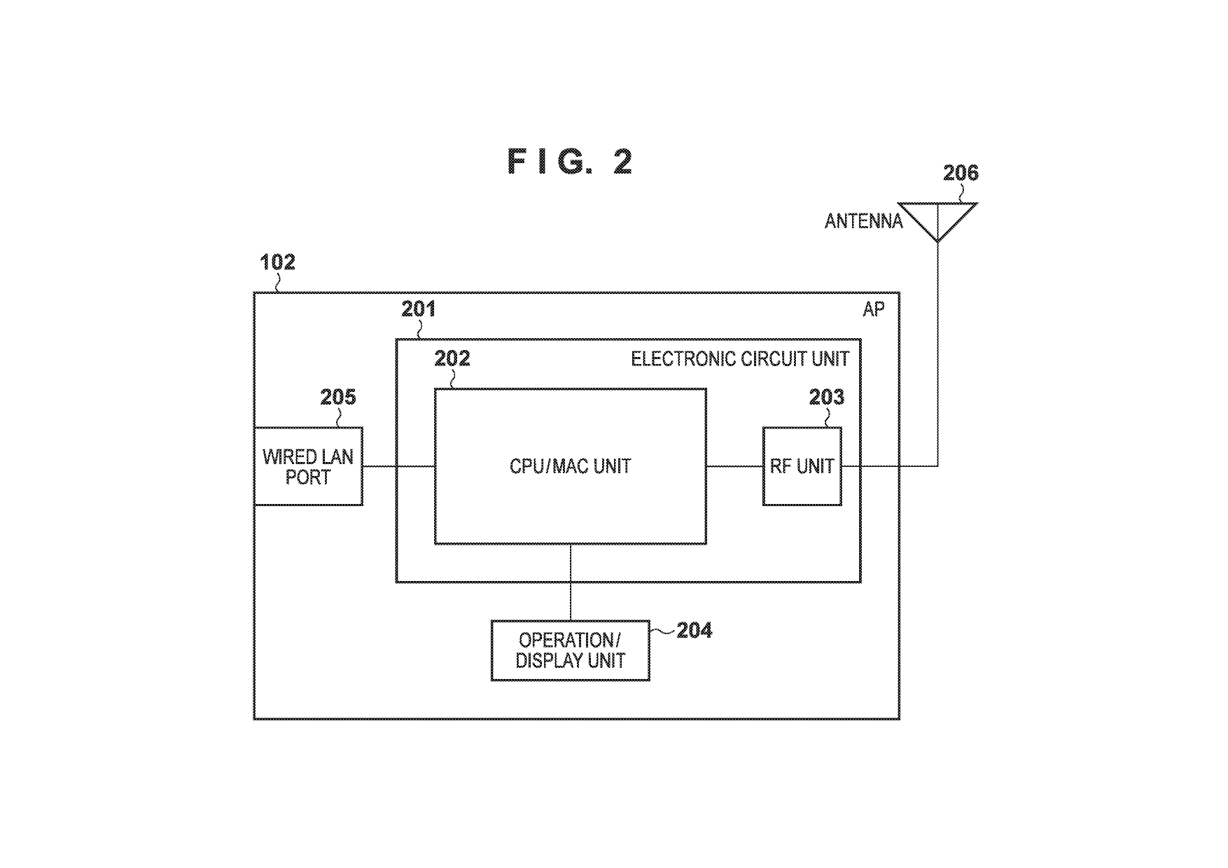

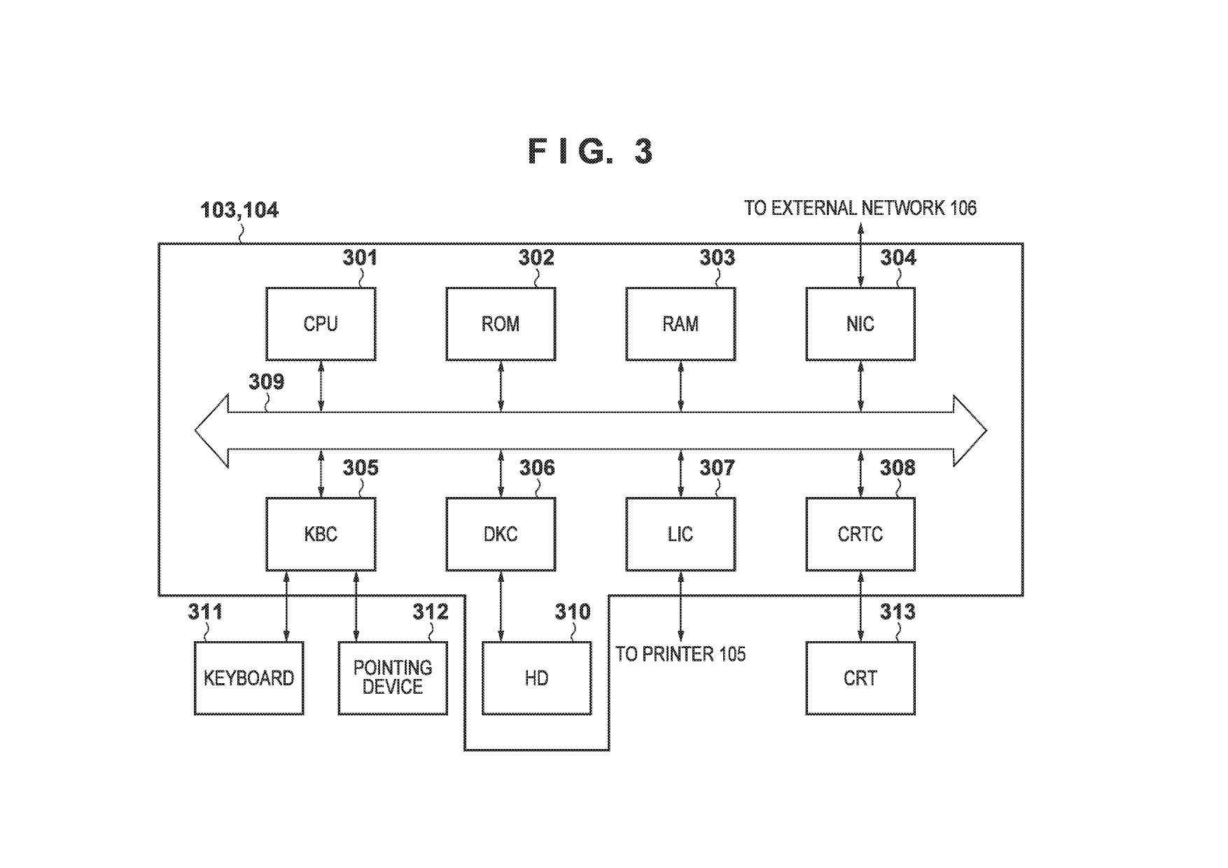

FIG. 1 is a view showing the overall configuration of a printing system in an embodiment. In the printing system, a mobile terminal device 101 transmits e-mail to which a file the user wants to print is attached, and can request a print server 104 to print by a printer 105. The mobile terminal device 101 has a size enough to carry it by hand. An operating system (OS) is installed in the mobile terminal device 101, and various applications can be executed on the OS. In the embodiment, an e-mail application serving as one application is executed in the mobile terminal device 101 to transmit e-mail by wireless communication. The mobile terminal device 101 can connect to a network 106 via an access point (AP) 102. The network 106 is, for example, a wired LAN (Local Area Network). The network 106 will be explained as a wired LAN. The internal arrangement of the access point 102 will be explained with reference to FIG. 2. As a mail server 103, for example, a general PC is used. A mail server application is installed in the mail server 103. The internal arrangement of the mail server 103 will be explained with reference to FIG. 3. The mail server 103 holds e-mail transmitted from the mobile terminal device 101.

As the print server 104, similar to the mail server 103, an information processing apparatus such as a general PC is used. The internal arrangement of the print server 104 will be explained with reference to FIG. 3. In the print server 104, printer drivers corresponding to respective printers connected to the wired LAN 106 are installed. The printer 105 prints on a printing medium such as paper based on print data in accordance with a print instruction from the print server 104. The wired LAN 106 is, for example, an Ethernet® cable, and connects the access point 102, mail server 103, print server 104, and printer 105 to each other to be able to communicate with each other.

FIG. 2 is a block diagram showing the internal arrangement of the access point 102. The access point 102 is an apparatus for allowing an apparatus (for example, the mobile terminal device 101) connected to a wireless communication network and an apparatus (for example, the mail server 103) connected to a wired communication network to communicate with each other. The access point 102 includes an electronic circuit 201, operation/display unit 204, and wired LAN port 205. The wired LAN port 205 includes a connector connectable to, for example, an Ethernet cable in order to connect the access point 102 to the wired LAN 106. The operation/display unit 204 includes an LED, switches, and the like, and distinctively displays the state of the main body of the access point 102 and the state of each port. The operation/display unit 204 may include a switch or the like for easy connection to a wireless LAN. The access point 102 may have a security function for safely performing wireless LAN connection.

The access point 102 includes a CPU/MAC unit 202, and radio frequency transmission/reception (RF (Radio Frequency)) unit 203. The CPU/MAC unit 202 incorporates a CPU and MAC (Media Access Control) (neither is shown). The CPU/MAC unit 202 also includes various processors, memories, and the like. Devices in the CPU/MAC unit 202 are connected to each other via a bus (not shown). The MAC has a portion which performs processing regarding wireless communication, and a portion which performs processing regarding wired communication.

As shown in FIG. 2, both the CPU/MAC unit 202 and RF unit 203 are arranged in the electronic circuit 201. The RF unit 203 is connected to an antenna 206 for transmitting/receiving radio waves. The CPU/MAC unit 202 is connected to the operation/display unit 204, RF unit 203, and wired LAN port 205. The access point 102 is connected to the wired LAN 106 via an Ethernet cable (not shown). In this case, one end of the Ethernet cable is connected to the wired LAN port 205, and the other end is connected to a network hub (not shown).

FIG. 3 is a block diagram showing the internal arrangement of the mail server 103 and print server 104. The embodiment uses information processing apparatuses such as general PCs as the mail server 103 and print server 104. Each of the mail server 103 and print server 104 includes a CPU 301, ROM 302, RAM 303, and network interface controller (NIC) 304. The respective units are connected to each other via a bus 309. A keyboard controller (KBC) 305, disk controller (DKC) 306, local interface controller (LIC) 307, and CRT controller (CRTC) 308 are also connected to each other via the bus 309.

For example, the above-mentioned Ethernet cable is connected to the network interface controller (NIC) 304. A keyboard 311 and pointing device 312 are connected to the keyboard controller (KBC) 305. A hard disk (HD) 310 is connected to the disk controller (DKC) 306. A peripheral device is connected to the local interface controller (LIC) 307 via a USB interface or the like. A CRT display 313 is connected to the CRT controller (CRTC) 308. The ROM 302 stores a basic I/O program, operating system (OS), and the like. The CPU 301 manages and executes various application programs based on the OS.

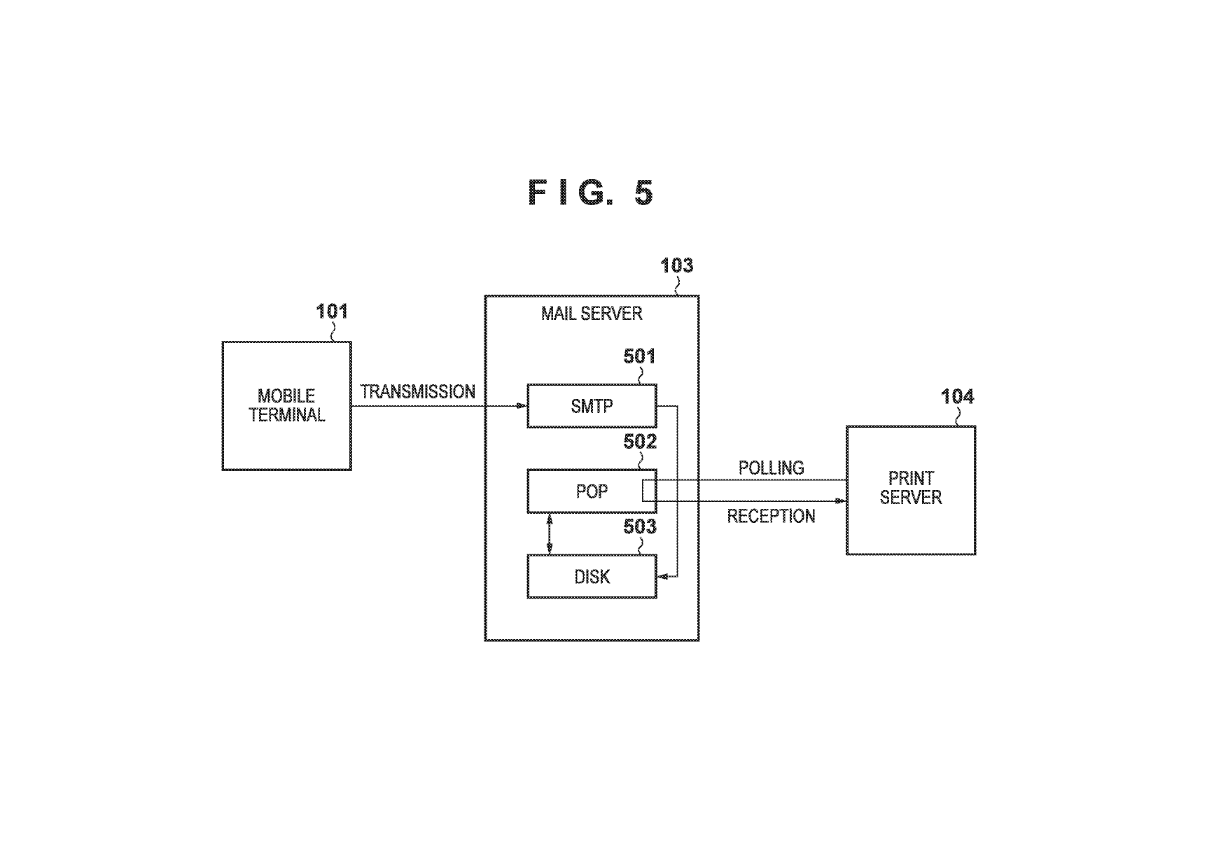

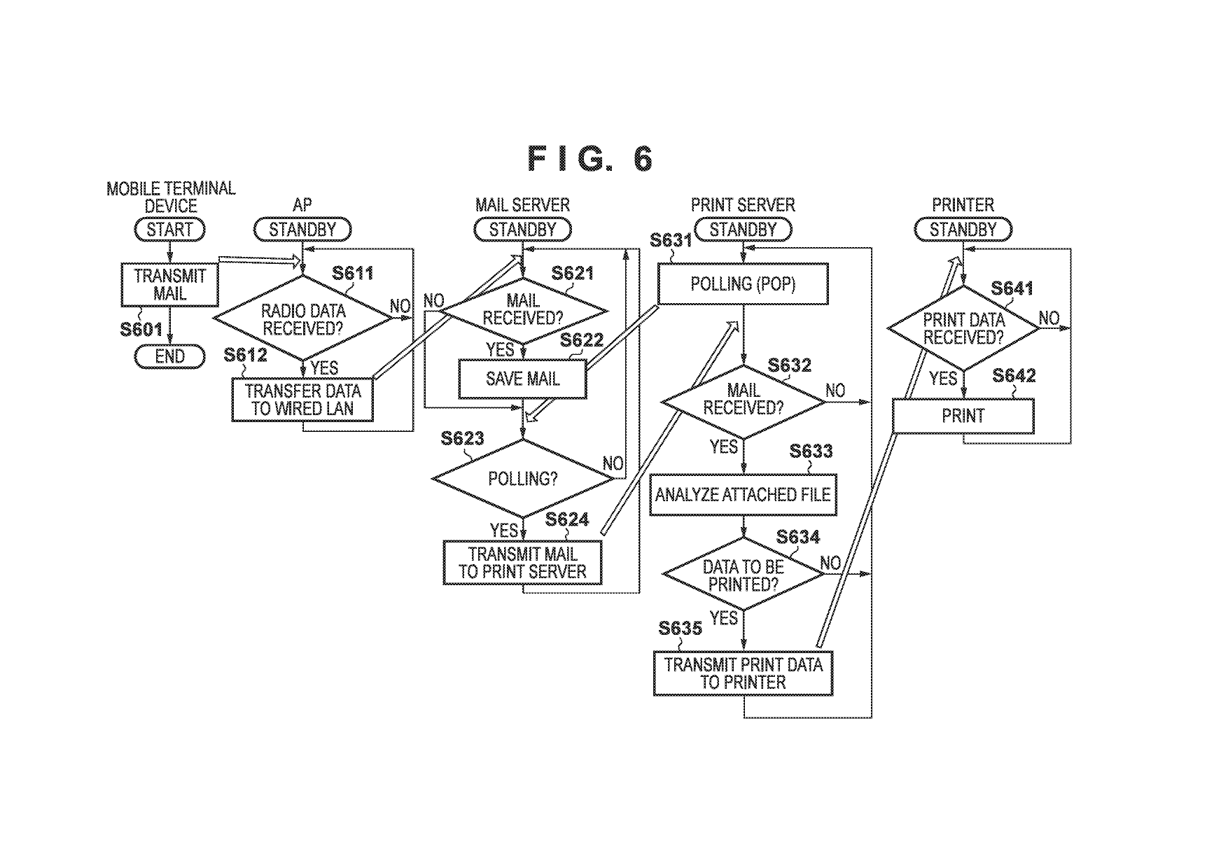

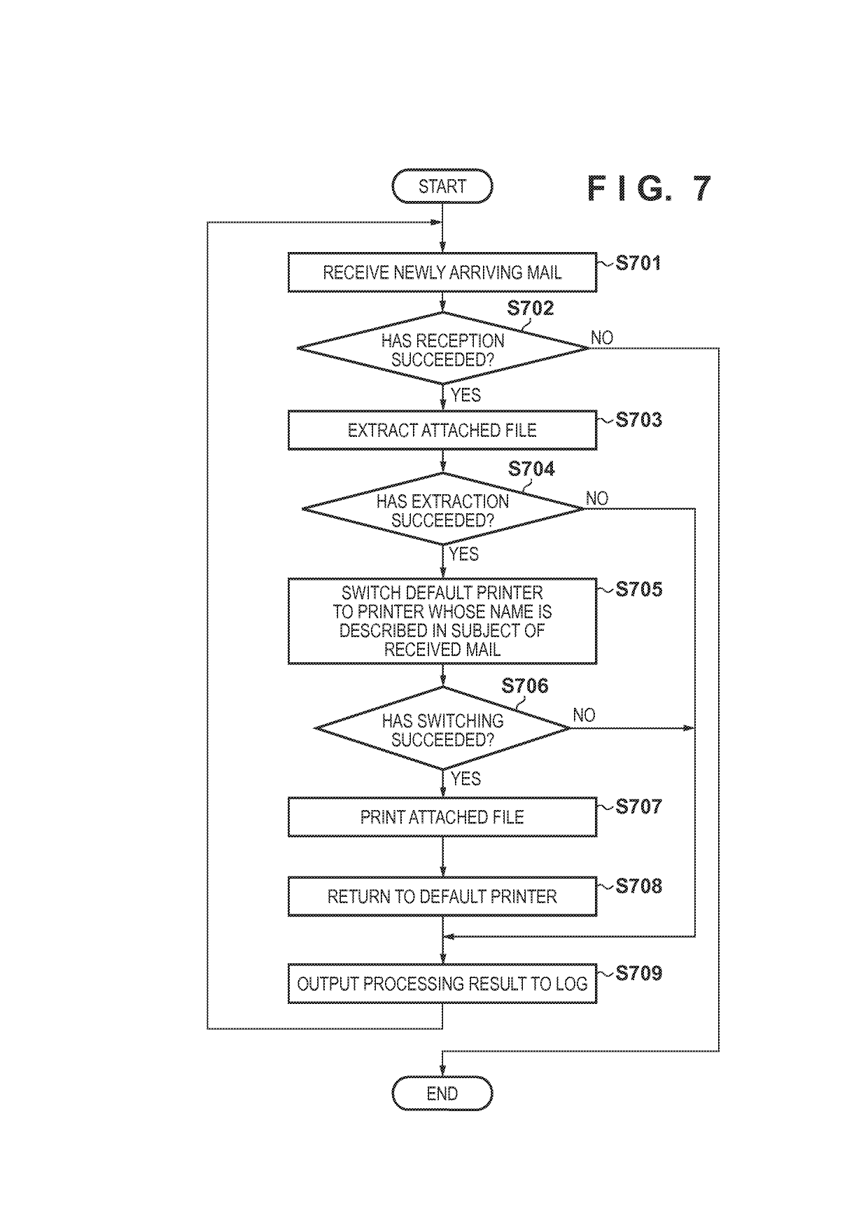

The hard disk (HD) 310 of the print server 104 stores a mobile terminal print application for implementing an operation according to the embodiment, various application programs, a printer driver which allows the print server 104 to control a printer, and the like. The mobile terminal print application is an application for implementing the operation of the printing system capable of printing an attached file from a mobile terminal, as shown in FIG. 6. The mobile terminal print application program stored in the hard disk 310 of the print server 104 implements, for example, processes as shown in FIGS. 7 and 10. The print server 104 has a mail client function and printer control function. By using these functions, the print server 104 can execute transmission/reception of e-mail and printing of a file attached to e-mail. The mail server function of the mail server 103 will be explained with reference to FIG. 5.

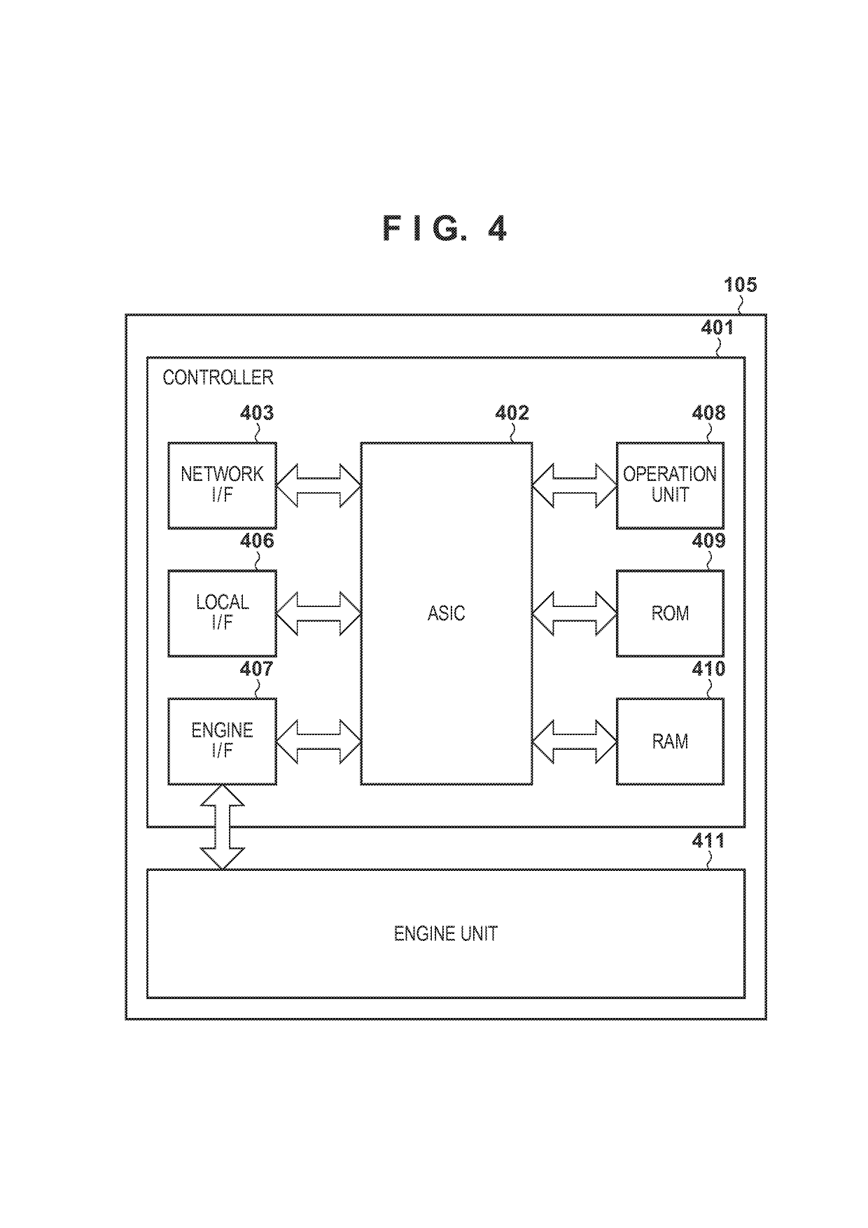

FIG. 4 is a block diagram showing the internal arrangement of the printer 105. A controller 401 performs print processing for print data received via a network interface 403 or local interface 406. The controller 401 includes a CPU (not shown), and an ASIC 402 which mainly transfers print data to an engine unit 411. An operation unit 408 displays the printing state of the printer to the user, and accepts an instruction operation from him. A ROM 409 stores various programs. A RAM 410 is used as an image rasterization area when performing print processing for print data, and the work area of the CPU. The network interface 403 communicates with the print server 104 or the like via an Ethernet interface, USB interface, or the like. A peripheral device is connected to the local interface controller (LIC) 406 via a USB interface or the like. An engine interface 407 sends print data having undergone print processing to the engine unit 411. The engine unit 411 controls each printing mechanism such as a printhead to print on a printing medium such as paper based on the received print data. Note that the printer includes all apparatuses each having at least the print function, such as a multi-function peripheral and FAX apparatus. FIG. 5 is a block diagram for explaining an e-mail transmission/reception operation centered on the mail server 103. First, an operation of receiving e-mail by the mail server 103 will be described. In the mail server 103, an SMTP (Simple Mail Transfer Protocol) server 501 and POP (Post Office Protocol) server 502 operate. The mobile terminal device 101 transmits e-mail to the mail server 103 by an e-mail application. The mail server 103 connected to the wired LAN 106 receives the transmitted e-mail via the access point 102 (not shown). In transmission of the e-mail, the e-mail application of the mobile terminal device 101 designates a predetermined mail address (destination) of the mail server 103. For example, the mail address is designated like “USER@mailprint.xx.jp”. Upon receiving the e-mail, the mail server 103 stores it in a hard disk 503 (corresponding to the hard disk 310 shown in FIG. 3) of the mail server 103.

Next, an operation of receiving e-mail by the print server 104 from the mail server 103 will be explained. The print server 104 polls the mail server 103 to confirm whether the POP server 502 of the mail server 103 has received e-mail, printing of which is requested by the mobile terminal device 101 in accordance with the operation of the mobile print application. At this time, the print server 104 designates a predetermined mail address (destination). The mobile print application arbitrarily designates the polling interval.

The POP server 502 of the mail server 103 requests a user name and password for the access from the print server 104 by polling. If it is confirmed that the user name and password are correct, the POP server 502 sends back the presence/absence of e-mail having the mail address of the print server 104, that is, the mail address designated by the print server 104, among e-mail messages accumulated in the mail server 103. If the target e-mail is accumulated in the POP server 502, the POP server 502 of the mail server 103 transmits the e-mail to the print server 104. Then, the print server 104 can acquire the e-mail from the mail server 103. FIG. 15 is a block diagram showing a case in which the e-mail transmission source is the print server 104 and the e-mail reception destination is the mobile terminal device 101, in contrast to the case of FIG. 5. Even in this case, similar to the above case, the mail server 103 can operate to transmit e-mail from the print server 104 to the mobile terminal device 101.

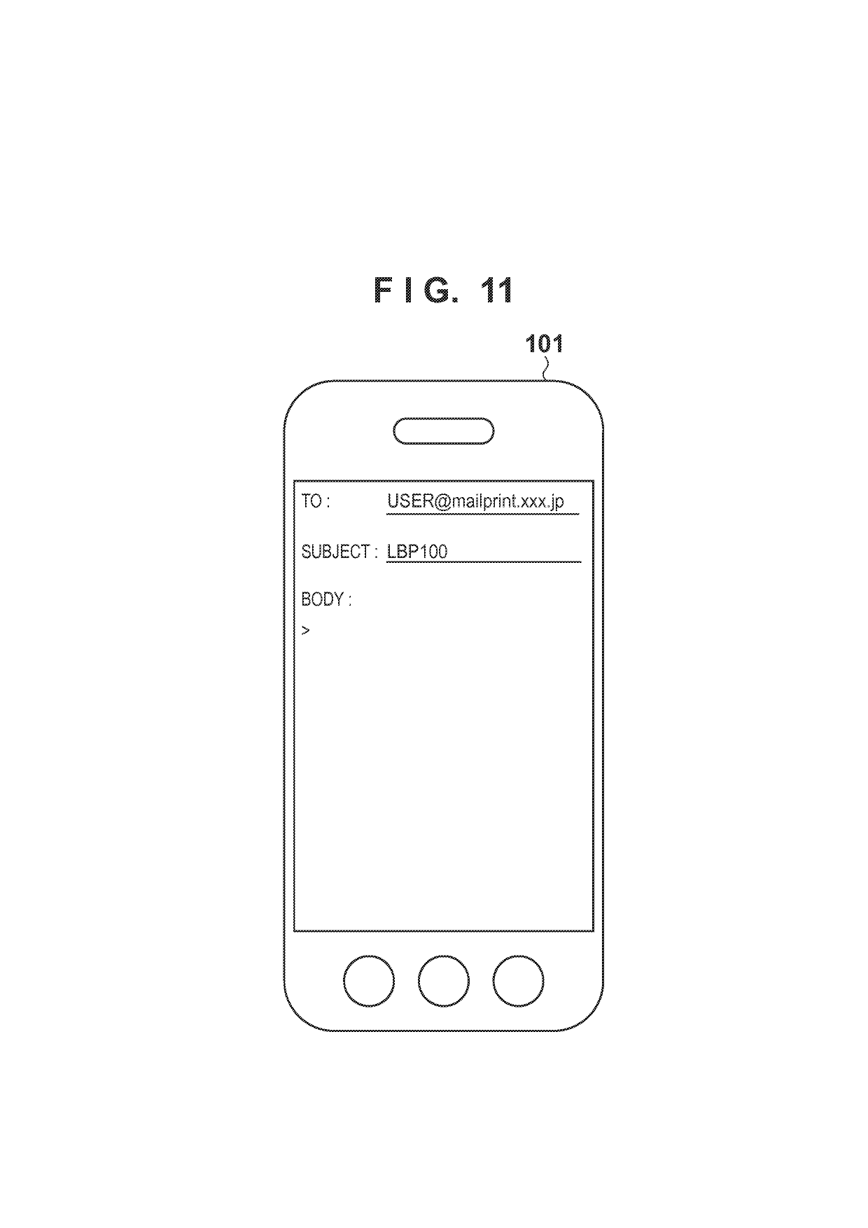

A processing sequence until the mobile terminal device 101 transmits e-mail to which a file the user wants to print is attached, and the printer 105 prints the file will be explained with reference to FIG. 6. First, in step S601, the e-mail application of the mobile terminal device 101 attaches, to e-mail, a file the user wants to print, and transmits the e-mail. FIG. 11 is a view exemplifying an e-mail transmission screen displayed on the display screen of the mobile terminal device 101 as a result of display control by the e-mail application. As shown in FIG. 11, the user enters, for example, “USER@mailprint.xx.jp” in the destination (“TO”) field. The user enters, in the subject field, the printer name of the printer by which the user wants to print the file. The printer name may be entered not in the subject filed but in the body. For example, “LBP100” is entered in the subject filed.

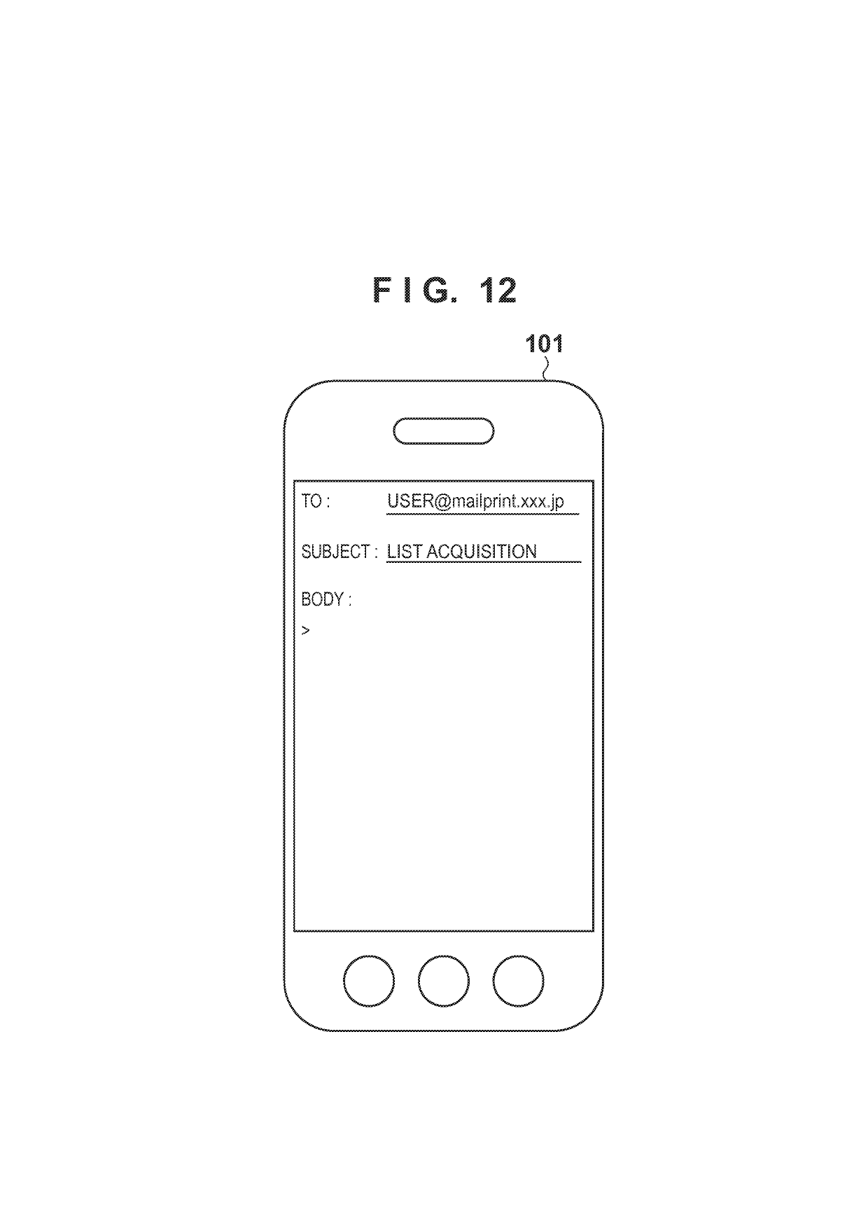

At this time, the user may not know the printer name. In this case, according to the embodiment, the user enters a keyword such as “list acquisition” as shown in FIG. 12 in the subject filed or body, and then transmits the e-mail. As a result, the user can acquire a list of printer names from e-mail received as the response, details of which will be described later with reference to FIG. 10.

After the user transmits the e-mail, the e-mail is transmitted to the access point 102 via the wireless LAN.

In step S611, the access point 102 receives, via the wireless LAN, the e-mail transmitted from the mobile terminal device 101. More specifically, a radio signal representing the e-mail is input from the antenna 206. The RF unit 203 converts the radio signal from an analog signal into a digital signal. The CPU/MAC unit 202 analyzes the destination and path of the e-mail from the converted digital signal, and transmits the digital signal to the wired LAN 106 via the wired LAN port 205. In step S612, the access point 102 transmits the e-mail to the SMTP server 501 of the mail server 103 via the wired LAN 106. The mail server 103 receives the e-mail in step S621, and stores it in the hard disk 310 together with the attached file in step S622.

At this time, the print server 104 polls the POP server 502 of the mail server 103 at a predetermined time interval in step S631. The polling operation has been described with reference to FIG. 5. Then, in step S623, the mail server 103 determines whether the print server 104 polls it. If the mail server 103 determines that the print server 104 polls it, the POP server 502 of the mail server 103 transmits, to the print server 104, e-mail having a mail address (destination) designated by the print server 104 and a file attached to it in step S624. The print server 104 receives the e-mail in step S632, and analyzes the file attached to it in step S633. In step S634, the print server 104 determines as a result of the analysis whether the attached file is a file to be printed. If the print server 104 determines that the attached file is a file to be printed, the print server 104 rasterizes the file attached to the e-mail into print data capable of print processing by the printer 105, and transmits the print data to the printer 105 in step S635.

In the embodiment, a file attached to e-mail is called an “attached file” until the print server 104 analyzes the file in step S633. To the contrary, data rasterized into data capable of print processing by the printer 105 after the analysis by the print server 104 in step S633 is called “print data”. The processes in steps S631 to S635 will be explained in detail with reference to FIG. 7. The printer 105 receives the print data from the print server 104 in step S641, and prints on a printing medium such as paper based on the print data in step S642.

FIG. 7 is a flowchart showing the detailed procedures of the print control processing in steps S631 to S635 shown in FIG. 6 that is executed by the print server 104. First, in step S701, the print server 104 polls the mail server 103, and receives e-mail from the mail server 103. In step S702, the print server 104 determines whether it has normally received the e-mail. If the print server 104 determines that it has not normally received the e-mail, the CPU 301 of the print server 104 ends the processing. If the print server 104 determines in step S702 that it has normally received the e-mail, the CPU 301 of the print server 104 extracts a file attached to the e-mail in step S703. The CPU 301 of the print server 104 controls the DKC 306 to store the attached file in the HD 310.

In step S704, the CPU 301 of the print server 104 determines whether the extraction of the attached file has succeeded. If the CPU 301 determines in step S704 that the extraction of the attached file has failed, it generates a processing result log representing that the extraction has failed. The CPU 301 of the print server 104 controls the CRTC 308 to display the processing result log on the CRT display 313. At the same time, the CPU 301 of the print server 104 stores the processing result log in the HD 310. The user can use the processing result log for troubleshooting. In step S705, the CPU 301 of the print server 104 switches the setting of the default printer to the setting of a printer indicated by “printer name” described in the subject field of the e-mail received in step S701.

In step S706, the CPU 301 of the print server 104 determines whether the switching of the printer setting has succeeded. If the CPU 301 of the print server 104 determines that the switching of the printer setting has succeeded, it performs print processing for the attached file in step S707. If the CPU 301 of the print server 104 determines in step S706 that the switching has failed, it generates a processing result log representing that the switching has failed. The CPU 301 of the print server 104 controls the CRTC 308 to display the processing result log on the CRT display 313. At the same time, the CPU 301 of the print server 104 stores the processing result log in the HD 310.

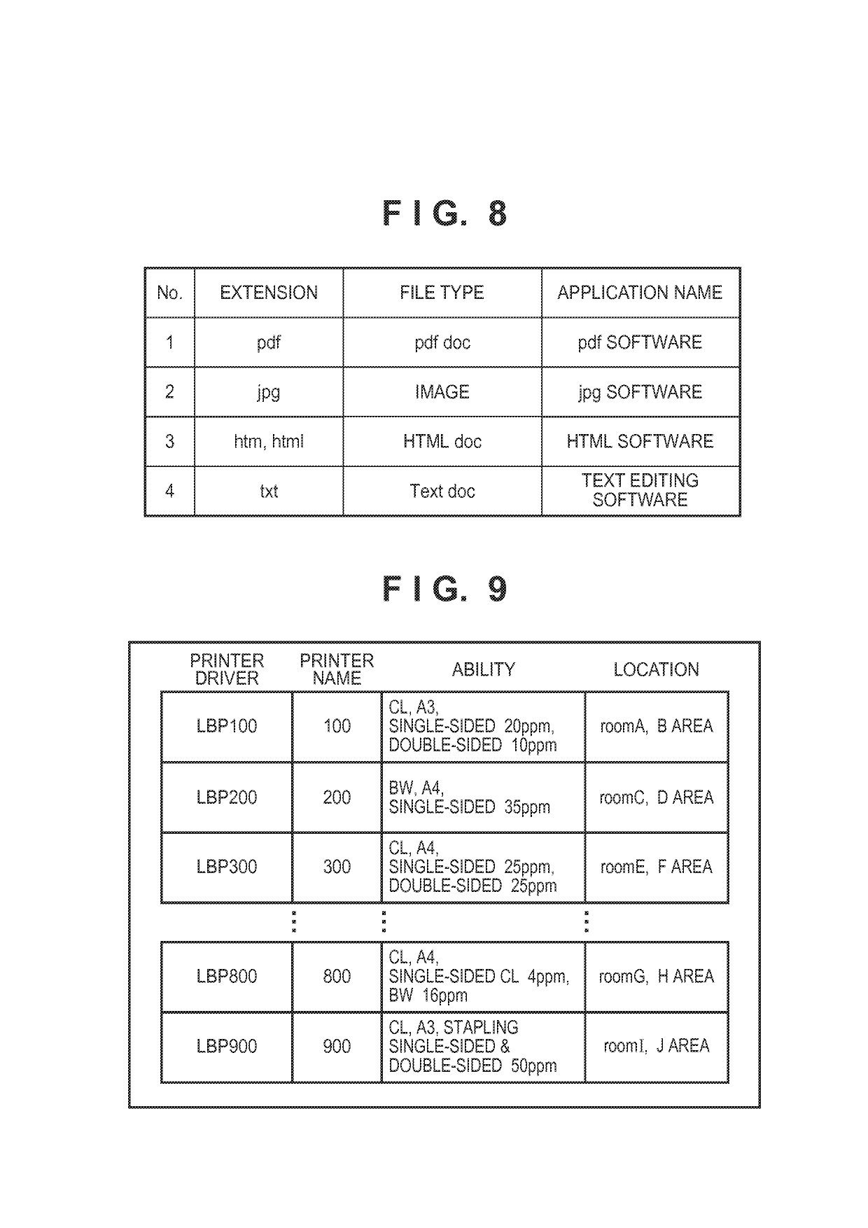

In step S707, the print server 104 refers to the extension of the attached file, activates an application program which corresponds to the extension and is stored in the HD 310 of the print server 104, and executes print processing using the print function of the application. For example, as shown in FIG. 8, the correspondence between the extension of a file attached to e-mail and an application implemented in the print server 104 may be defined in advance in the table form. By looking up a table as shown in FIG. 8, the CPU 301 of the print server 104 can activate the print function of an application adapted to the extension. The table shown in FIG. 8 may be stored in the HD 310 in the print server 104, and acquired on the operation of the mobile print application program stored in the HD 310.

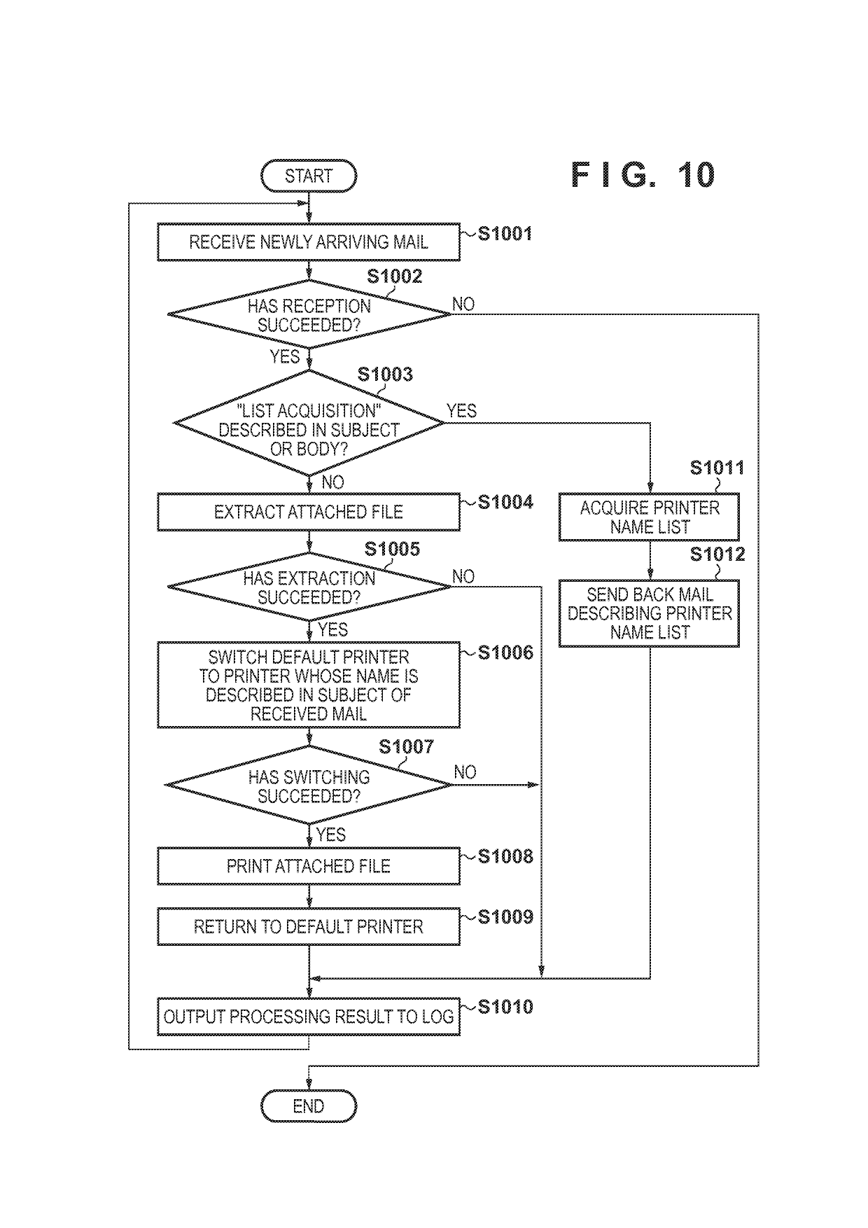

The CPU 301 of the print server 104 activates a printer driver corresponding to the output destination printer switched in step S705, rasterizes print data in the RAM 303, and transmits the rasterized print data to the switched printer. Note that the printer driver and printer name are made to correspond to each other in the table form, as shown in FIG. 9. When a new printer is connected to the wired LAN 106 or to the local interface of the print server 104, the CPU 301 of the print server 104 sequentially adds information of the printer driver and printer name of the new printer to the table shown in FIG. 9. Similarly, as for “printability information” of each printer, the CPU 301 of the print server 104 acquires it from the printer 105 upon connection of the printer, and sequentially adds it to the table shown in FIG. 9. As for “location information” of a printer, when or after a printer driver is installed, the CPU 301 of the print server 104 acquires information set by the administrator of the print server 104, and sequentially adds it to the table shown in FIG. 9. The table shown in FIG. 9 is held in, for example, the HD 310 of the print server 104.

Referring back to FIG. 7, after the end of the print processing for the attached file that started in step S707, the CPU 301 of the print server 104 returns the setting of the printer to that of the default printer in step S708. In step S709, the CPU 301 of the print server 104 generates a processing result log representing that the printing has ended normally. The CPU 301 of the print server 104 controls the CRTC 308 to display the processing result log on the CRT display 313. At the same time, the CPU 301 of the print server 104 stores the processing result log in the HD 310.

Next, a processing sequence until the print server 104 transmits e-mail to which printer name list information is added, after receiving request mail requesting a printer name list will be explained with reference to FIG. 10. First, in step S1001, the CPU 301 of the print server 104 polls the mail server 103, and receives e-mail from the mail server 103. In step S1002, the CPU 301 of the print server 104 determines whether it has normally received the e-mail. If the CPU 301 of the print server 104 determines that it has not normally received the e-mail, it ends the processing.

If the CPU 301 of the print server 104 determines in step S1002 that it has normally received the e-mail, it determines in step S1003 whether “list acquisition” is described in the subject field or body of the received e-mail. That is, the CPU 301 of the print server 104 determines whether the e-mail contains request information requesting a printer list. If the CPU 301 of the print server 104 determines that “list acquisition” is not described, it extracts a file attached to the e-mail in step S1004. Subsequent processes in steps S1004 to S1010 are the same as those in steps S703 to S709 of FIG. 7.

If the CPU 301 of the print server 104 determines in step S1003 that “list acquisition” is described, it acquires pieces of information “printer name”, “ability information”, and “location information” from the table shown in FIG. 9 in step S1011. In step S1012, the CPU 301 of the print server 104 creates e-mail in which a list of the pieces of information acquired in step S1011 is described in the body of the e-mail, and sends it back to the transmission source of the e-mail received in step S1001. Note that the table shown in FIG. 9 may be directly attached as an attached file to send back e-mail, instead of describing, in the body, a list of the pieces of information acquired in step S1011. The e-mail transmitted by the print server 104 is transmitted to the mobile terminal device 101 via the mail server 103. As a result, the mobile terminal device 101 receives the e-mail, and the user of the mobile terminal device 101 can acquire the printer name list.

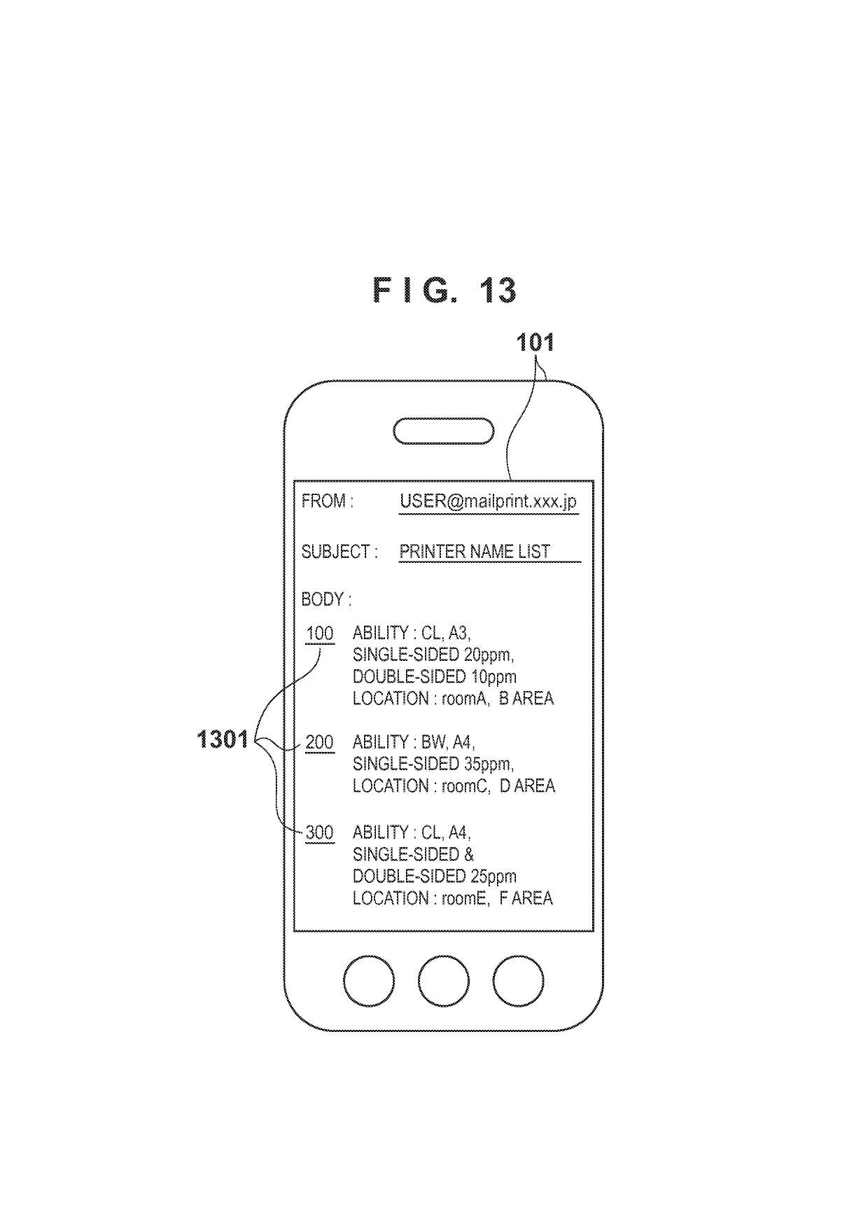

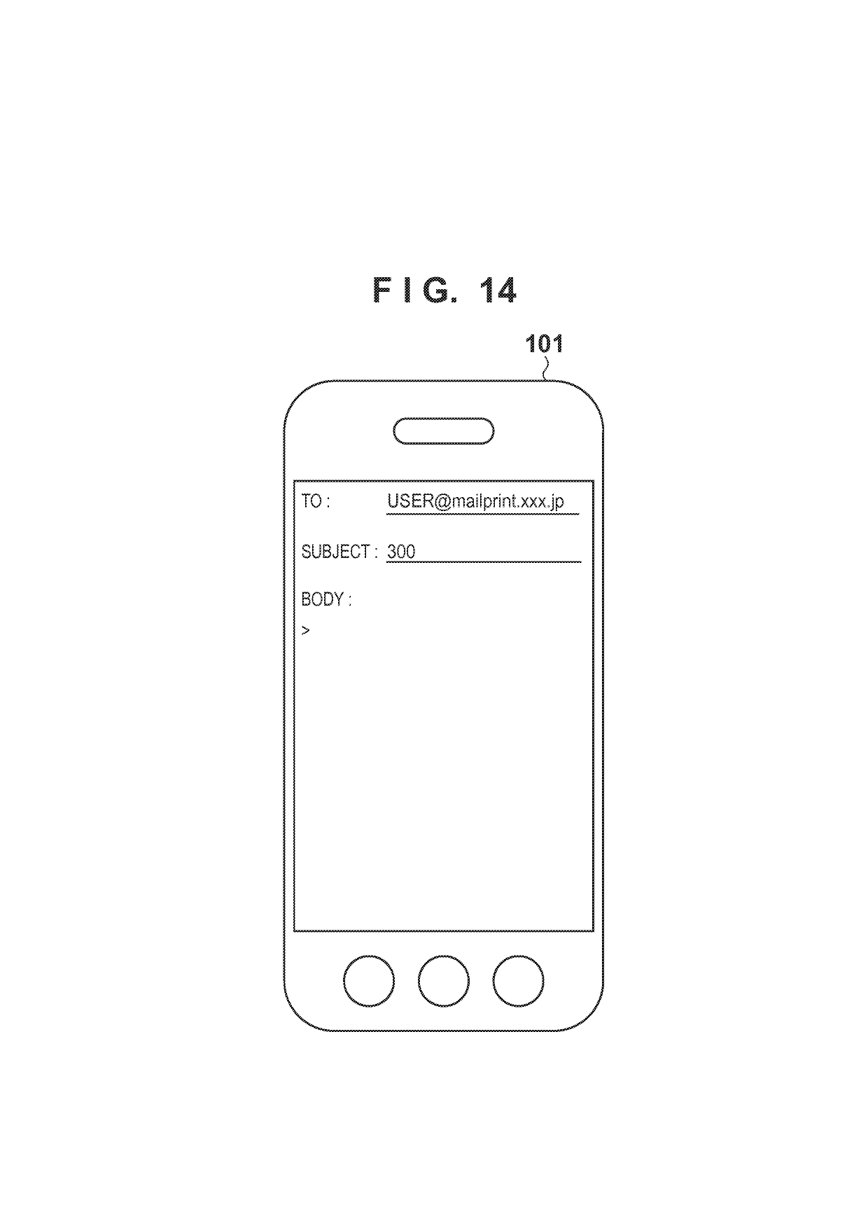

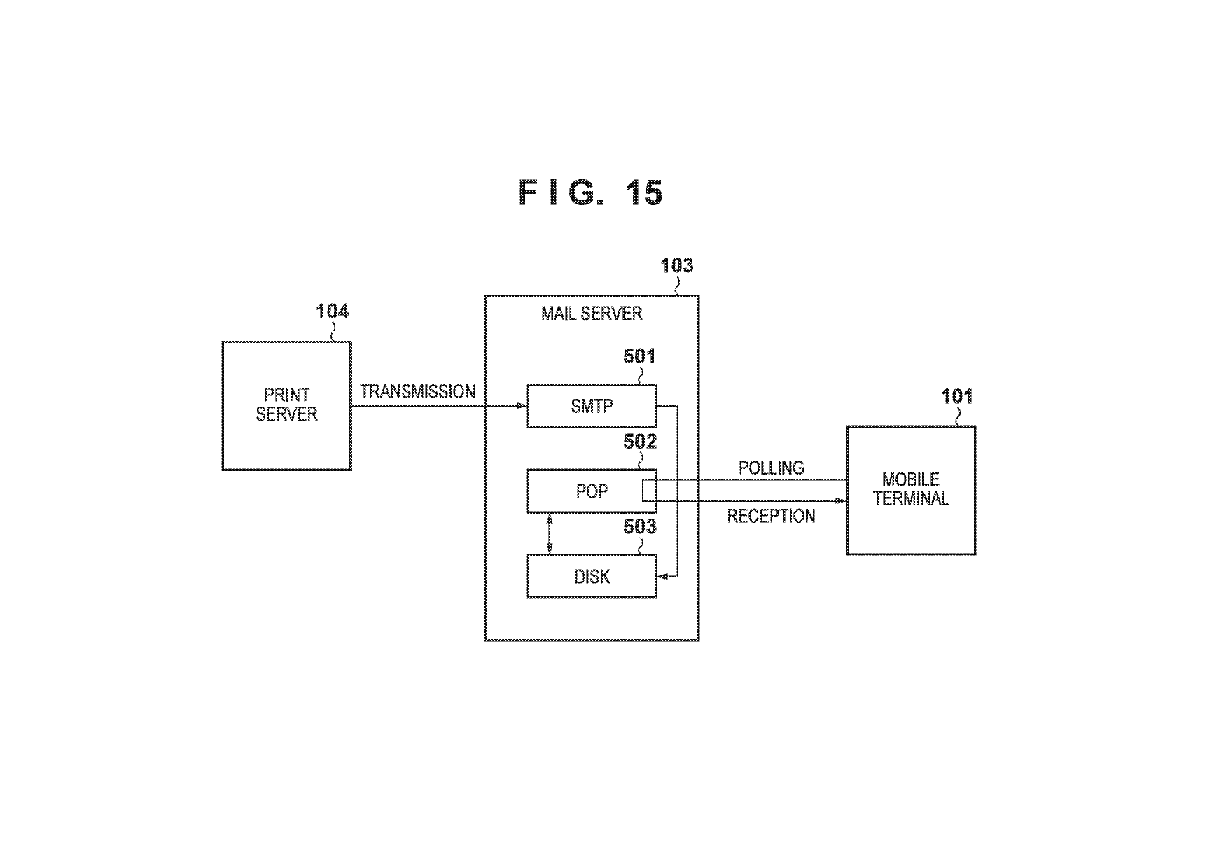

FIG. 13 is a view exemplifying an e-mail reception screen displayed on the display screen when the mobile terminal device 101 acquires a printer name list. As shown in FIG. 13, ability information and location information of each printer are displayed together with its printer name. The user of the mobile terminal device 101 can easily select and specify a printer to print on the displayed list. When the user selects a printer name 1301 he wants on the display screen shown in FIG. 13, the e-mail application of the mobile terminal device 101 designates a predetermined mail address of the mail server 103 as the destination. Then, the e-mail application of the mobile terminal device 101 creates e-mail in which the printer name selected by the user has been entered in the subject field, and displays the contents on the display screen. Even on the mobile terminal device on which it is cumbersome to enter a text and the like, the user can easily select a printer to print, improving user friendliness. FIG. 14 is a view exemplifying the e-mail transmission screen of the mobile terminal device 101 that is displayed when the user selects a printer name “300” in FIG. 13. On the screen shown in FIG. 14, the user suffices to attach, to the e-mail, a file he wants to print, and transmit the e-mail.

When the print server 104 receives the e-mail containing the description of a printer name list request from the mobile terminal device 101, it acquires printer name list information held in the print server 104, adds the list information to e-mail, and sends back the e-mail to the mobile terminal device 101. Hence, the user can acquire the printer name list by only transmitting the list acquisition request e-mail from the mobile terminal device 101, greatly improving user friendliness.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-007382, filed Jan. 17, 2012, which is hereby incorporated by reference herein in its entirety.

What is claimed is:

1. An information processing apparatus comprising:
an e-mail acquisition unit configured to acquire e-mail;
a determination unit configured to determine whether the e-mail acquired by said e-mail acquisition unit includes request information requesting a printer list;
a list acquisition unit configured to acquire a list of printers controllable by the information processing apparatus in a case where said determination unit determines that the e-mail includes the request information; and
a transmission unit configured to transmit, as a response to the request, e-mail including the printer list acquired by said list acquisition unit.

2. The apparatus according to claim 1, wherein, based on presence/absence of a keyword representing the request information in a subject field or body of the e-mail acquired by said e-mail acquisition unit, said determination unit determines whether the e-mail includes the request information.

3. The apparatus according to claim 1, further comprising a storage unit configured to store the printer list,
wherein said list acquisition unit acquires the printer list from said storage unit.

4. The apparatus according to claim 1, wherein the printer list includes information of a print function executable by a printer.

5. A mobile terminal comprising:
a first e-mail transmission unit configured to transmit e-mail including request information requesting a printer list;
an e-mail reception unit configured to receive e-mail including the printer list;
a display control unit configured to display, on a display unit of the mobile terminal, the printer list included in the e-mail received by said e-mail reception unit;
an acceptance unit configured to accept selection of a printer on the printer list displayed on the display unit; and
a second e-mail transmission unit configured to transmit e-mail to which the file to be printed by the selected printer is attached.

6. A printing system in which a mobile terminal requests an information processing apparatus to print a file,
the information processing apparatus comprising:
an e-mail acquisition unit configured to acquire e-mail;
a determination unit configured to determine whether the e-mail acquired by said e-mail acquisition unit includes request information requesting a printer list;
a list acquisition unit configured to acquire a list of printers controllable by the information processing apparatus in a case where said determination unit determines that the e-mail includes the request information; and
a first transmission unit configured to transmit, as a response to the request, e-mail including the printer list acquired by said list acquisition unit, and
the mobile terminal comprising:
a second transmission unit configured to transmit e-mail including request information;
a reception unit configured to receive e-mail including the printer list;
a display control unit configured to display, on a display unit of the mobile terminal, the printer list included in the e-mail received by said reception unit;
an acceptance unit configured to accept selection of a printer on the printer list displayed on the display unit; and
a third transmission unit configured to transmit e-mail to which the file to be printed by the selected printer is attached.

7. A print control method to be executed in a printing system in which a mobile terminal requests an information processing apparatus to print a file, comprising:
in the information processing apparatus,
an e-mail acquisition step of acquiring e-mail;
a determination step of determining whether the e-mail acquired in the e-mail acquisition step includes request information requesting a printer list;
a list acquisition step of acquiring a list of printers controllable by the information processing apparatus in a case where the e-mail is determined in the determination step to include the request information; and
a first transmission step of transmitting, as a response to the request, e-mail including the printer list acquired in the list acquisition step, and
in the mobile terminal,
a second transmission step of transmitting e-mail including the request information;
a reception step of receiving e-mail including the printer list;
a display control step of displaying, on a display unit of the mobile terminal, the printer list included in the e-mail received in the reception step;
an acceptance step of accepting selection of a printer on the printer list displayed on the display unit; and
a third transmission step of transmitting e-mail to which the file to be printed by the selected printer is attached.
